(19) United States
(12) Patent Application Publication
(10) Pub. No.: US 2024/0298063 A1
(43) Pub. Date: Sep. 5, 2024

(54) INTERACTIVE OVERLAY ON PREEXISTING VIDEO SYSTEM AND METHOD

(71) Applicant: Michael Cafiero, Largo, FL (US)

(72) Inventor: Michael Cafiero, Largo, FL (US)

(21) Appl. No.: 18/443,765

(22) Filed: Feb. 16, 2024

Related U.S. Application Data
(60) Provisional application No. 63/488,091, filed on Mar. 2, 2023.

(51) Int. Cl. H04N 21/431; G06T 13/80; H04N 21/4784; H04N 21/858

(52) U.S. Cl. CPC H04N 21/4316; G06T 13/80; H04N 21/4784; H04N 21/8586

(57) ABSTRACT

The invention relates to a computer-implemented method for generating and rendering interactive digital content to enhance viewer engagement and accurately measure viewer interaction. This method involves receiving a unique identifier for a video stored on a video hosting server and creating a record associated with this video in a data store. A unique URL is determined for the viewer to access this interactive content, which includes the video and overlaid animated images. These animated images appear at specified times and locations over the video, requiring viewer interaction, such as clicks or taps, to be tracked and recorded. The method further allows for the generation of a web page displaying this interactive content, capturing viewer interactions, and optionally offering a reward based on these interactions. This novel approach ensures an engaging viewer experience while providing a reliable measure of viewer attention and interaction with the digital content.

### CROSS-REFERENCE TO RELATED APPLICATIONS

This application claims priority to and the benefit of U.S. Provisional Patent Application No. 63/488,091, filed Mar. 2, 2023, the entirety of which is incorporated herein by reference.

### FIELD OF THE INVENTION

The present invention relates to the field of video augmentation on a computer system.

### BACKGROUND

With the advent of digital advertising and the proliferation of digital content platforms, a technical challenge has arisen in determining the extent to which users actually engage with digital content. Typical web analytics solutions tend to use a combination of cookies, web beacons (e.g., tracking codes), and/or uniform resource locator (URL) parameters to gather information about how users interact with web pages. However, video-based digital advertisements are often simply played with an embedded video player on a website, which offer limited to no user activity tracking—especially in cases where the video player is embedded as an inline frame (iframe).

While some embeddable video playback solutions can track basic activity, such as how long a video was played, whether it was paused, or whether the user jumped to a different part of the video, these basic activities do not necessarily relate to whether the user actually paid attention to the video and/or noticed specific details of the video. For instance, a video can play back to a user, but they can simply choose not to pay attention to it and return back to their device once the video concludes without having paid any attention to the video. As a result, data from existing video playback activity tracking solutions may inaccurately reflect the extent to which users actually paid attention to a digital video advertisement. As digital advertising becomes increasingly saturated, the desire for digital advertising solutions that increase user engagement—and meaningfully measure the extent of that engagement—has grown considerably.

### SUMMARY

Digital wireless communication has traditionally been achieved through WLANs and mobile broadband communications. For example, a user may install a wireless router in that user's home that enables that user to connect his or her networked devices across that WLAN and/or to the Internet by way of a modem or the like. While that WLAN is suitable to provide wireless networking within the home, the strength of the WLAN signal may diminish with increasing distance from the home to the surrounding premises. For instance, the WLAN signal may be inadequate to facilitate communication with a device positioned in the user's yard or along the street or sidewalk.

A computer-implemented method for generating interactive digital content, includes operations that include receiving, at a server, a first unique identifier associated with a video stored on a video hosting server. The video may be accessible via an application programming interface (API) of the video hosting server over a network. The operations also include creating, based at least in part on the first unique identifier associated with the video, a record in a data store. The record stores at least the first unique identifier in association with a second unique identifier. The operations further include determining a uniform resource locator (URL) based in part on the second unique identifier and associated with the record in the data store. Additionally, the operations include transmitting the URL to a viewer client device. Further, the operations include receiving, from the viewer client device, a request to view interactive digital content associated with the URL. The operations further include generating a web page that includes the interactive digital content upon receiving the request. The interactive digital content includes at least (i) the video associated with the first unique identifier and (ii) one or more animated images.

Generating the web page may involve performing steps, including determining, for each of the one or more animated images, a start time and an end time that occur within a duration of the video to display the respective animated image. The steps also include determining, for each of the one or more animated images, a location to display the respective animated image relative to the video. The steps further include generating a web page that (a) displays each of the one or more animated images at their respective locations between their respective start and end times superimposed onto the video and (b) captures and transmits user interactions with content on the web page to the server.

The operations of the computer-implemented method also includes transmitting, in response to the request, the web page to the viewer client device.

In some implementations, the operations may further include receiving, at the server, data indicative of user activity captured by the viewer client device while rendering the web page. Additionally, the operations may further include determining that the received data indicative of the user activity satisfies one or more criteria. The one or more criteria may include whether the user interacted with all of the one or more animated images of the interactive digital content. Further, the operations may include transmitting a message to a user of the viewer client device that includes information about a reward for viewing and interacting with the interactive digital content based on the determination that the received data indicative of the user activity satisfies the one or more criteria.

A non-transitory computer readable medium having instructions stored thereon that, upon execution by at least one processor, causes a viewer client device to perform operations is disclosed. The operations include receiving, from a server, a web page that includes interactive digital content. The interactive digital content may include at least (i) a video and (ii) one or more animated images, with each of the one or more animated images being configured to be displayed at a respective location relative to the video between a respective start time and a respective end time. The operations also include retrieving, from a video hosting platform, the video for playback. The operations further include beginning playback of the interactive digital content. Additionally, the operations include receiving one or more input events representative of user activity related to the interactive digital content, The one or more input events may include clicks or taps on the one or more animated images while they are shown superimposed onto the video. Further, the operations include transmitting data representative of the one or more input events to the server. In addition, the operations include receiving, from the server, a message directed to a user of the viewer client device that includes information about a reward for viewing and interacting with the interactive digital content.

### BRIEF DESCRIPTION OF THE DRAWINGS

To assist in understanding the disclosure, and to show how embodiments of the present application may be implemented, there will now be described by way of example specific embodiments, apparatuses, systems, and methods with reference to the accompanying drawings, in which:

FIG. 1 is a schematic view of an example system for generating interactive digital content and transmitting that interactive digital content to a viewer computer system, according to various aspects of the present disclosure;

FIG. 2 is a schematic view of an example user interface for displaying interactive digital content to an end user, according to various aspects of the present disclosure; and

FIG. 3 is a flowchart illustrating an example process for generating interactive digital content, according to various aspects of the present disclosure.

### DETAILED DESCRIPTION

There will now be described, by way of example, several specific embodiments of the invention as contemplated by the inventor. In the following description, specific details are set forth in order to provide a thorough understanding of the embodiments. It will be apparent, however, that the embodiments of the present invention may be practiced without limitation to these specific details. The specific details disclosed herein are not intended to limit the scope of the present application.

Example embodiments of the present disclosure involve video augmentation methods and systems that increase user engagement, interactivity, and the detection and measurement of user attention. In the digital advertising landscape, current tracking methods like cookies and web beacons fall short in accurately gauging user engagement with video content, as they only track basic interactions like play duration and pausing. These metrics don't necessarily indicate whether users are genuinely paying attention to video advertisements. In various applications, such as digital advertising, robust and accurate solutions to tracking user engagement is particularly desirable—especially as users have grown accustomed to identifying digital advertising and have become better at ignoring those advertisements.

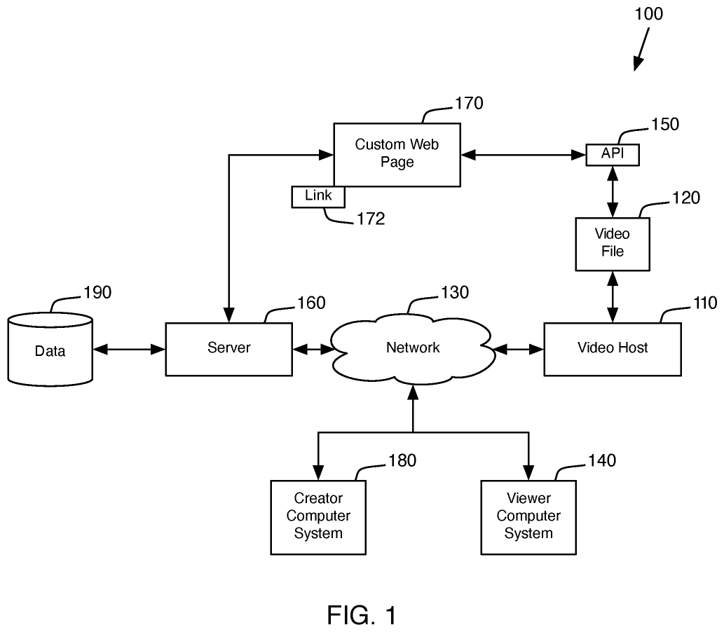

The present disclosure describes a system 100, as shown in FIG. 1. In this system, a video hosting platform 110 hosts at least one video file 120 over a network 130. The video hosting platform 110 then makes the video file 120 available to users over the network 130. For instance, the viewer computer 140 could access the video hosting platform 110 over the network 130 and then present the video file 120 to a user of the viewer computer 140. In this context, the network 130 could be the Internet, the video host 110 could be YouTube (from YouTube LLC of San Bruno, CA), and the interactions could take place on the World Wide Web, with a web page presented by the video host 110 embedding a video player and the video file 120.

The video host 110 frequently provides an application programming interface, such as API 150, to allow the video file 120 to be accessed through other web pages. In system 100, a server 160 presents the view file 120 using a custom web page 170 that utilizes this API 150. In particular, the server 160 responds to a request from a creator computer system 180 to generate the custom web page 170 for the video file 120. The creator computer system 180 can specify a particular file, such as the video file 120 through a user interface provided by the server 160 over the network 130. Once specified, the server 160 generates the custom web page 170 and provides a link 172 to the custom web page 170 to the creator computer system 180. This link 172 may take the form of a website URL. The user interface provided by the server 160 may provide an automatic method to share the link 172 with another system, such as the viewer computer 140. Alternatively, the user of the creator computer system 180 can provide the link 172 that they receive from the server 160 to the user of the viewer computer 140 outside of the system 100.

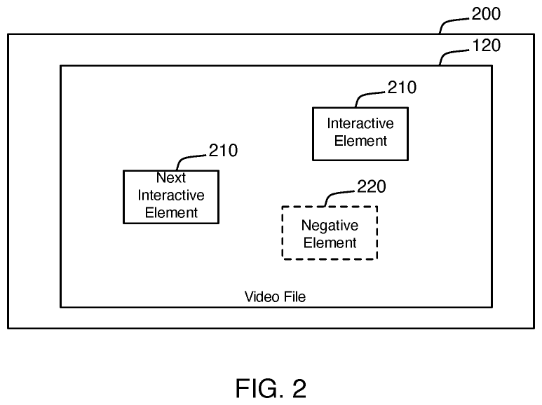

The viewer computer 140 then uses the link 172 to access the custom web page 170 in order to view the video file 120. The custom web page 170 uses the API 150 to access and present the video file 120 in a user interface, such as interface 200 shown in FIG. 2. In addition to simply presenting the video file 120, the server 160 presents through interface 200 a programmed “overlay” on top of the presented video file 120. This overlay is designed to ensure that the user of the viewer computer 140 is paying attention to the video file 120. In one embodiment, the overlay presents an interactive element 210 that is shown on top of a small portion of the displayed video file 120. The interactive element 210 is presented for only a short time.

During the presentation of the interactive element 210, the user is instructed to perform some action, such as to “click” on the interactive element 210. If the user successfully clicks on the interactive element 210, this is considered a successful interaction, and data related to the successful interaction is saved in a data store 190 maintained by the server 160. If the user fails to click on the interactive element 210 before it is removed from the interface 200, this is considered an unsuccessful interaction. Data about the unsuccessful interaction is also stored in the data store 190. The data stored in the data store 190 relates to a particular viewer computer 140, or a particular user of the viewer computer 140. To ensure knowledge about this user, the server 160 may require a registration/login procedure before allowing the viewer computer 140 to view the video file 120 through the interface 200. Alternatively, the link 172 created when the custom web page 170 was generated may be specific to a particular viewing user. The creator computer system 180 can specify this when the custom web page 170 is created through the server 160.

Typically, multiple interactive elements 210 are presented, one at a time, during the presentation of the video file 120. In a three-minute video, four interactive elements 210 may be presented, each for 10-15 seconds. In a thirty-minute video, eight interactive elements 210 may be presented. When the viewing is complete, the server 160 provides data about the interaction between the viewer computer 140 and the custom web page 170 to the creator computer system 180. If all interactions with the interactive elements 210 were successful, the user of the creator computer system 180 will be assured that the viewer receiving the link 172 not only played the video file 120, but paid attention during the playing of the video file 120.

In some embodiments, one or more negative elements 220 may be displayed simultaneously with an interactive element 210, with the viewer being instructed not to interact with the negative elements 220. If the user taps or clicks on the negative element 220, the system can track the interaction and update the viewer's score to potentially prevent the user from receiving a reward for failing to follow the instructions.

In some embodiments, questions concerning this video are presented through the interface 200 upon the completion of the video file 120. Answers to these questions are received and scored. Correctly answering these questions may be required in addition to successful interactions with the interactive element 210 to successfully view the video file 120.

In some embodiments, a reward is specified by the creator computer system 180 when the link 172 is presented to the viewer computer 140. The user of the viewer computer 140 is then aware that if they successfully interact with all of the interactive elements 210 during the presentation of the video file 120, they will receive the award. If the award is digital in nature, it can be presented directly by the server 160 to the viewer computer 140 after such a success. The reward may require a physical object. In some embodiments, the presentment or delivery of the physical object reward can still be triggered by the server 160. In other embodiments, the reward might be presented by the user of the creator computer system 180 to the user of the viewer computer 140 outside of the system 100.

In some embodiments, instead of using the link 172 to access a video file 120 hosted by another system (video hosting platform 110), the video file 120 will hosted directly by the server 160. As such, there will be no need to embed the video file on the custom web page 170 using the API 150. Rather, the server 160 will directly present the video file 120 within a full video player.

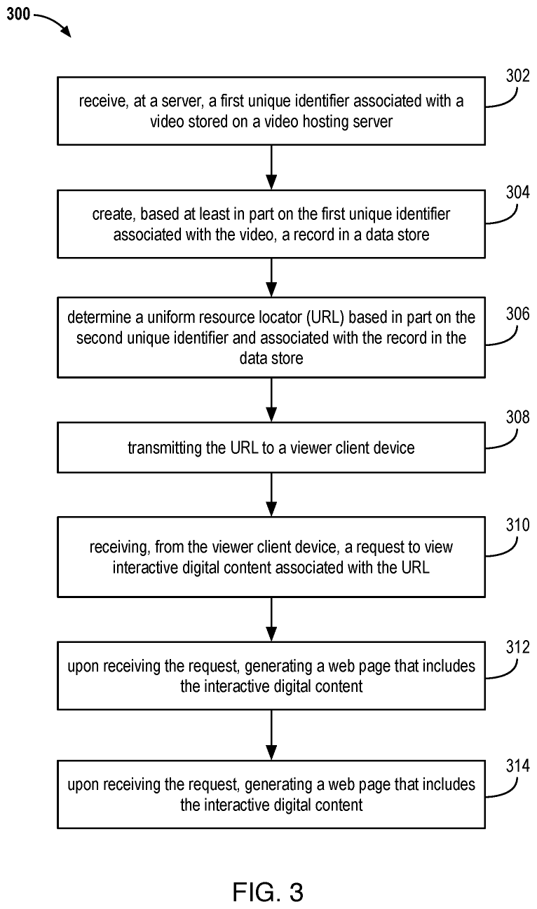

FIG. 3 is a flowchart illustrating an example process 300 for generating interactive digital content. Some or all of the steps of process 300 may be carried out by the server 160 as shown and described with respect to FIG. 3. However, in various embodiments, aspects of the process 300 may be carried out by the creator computer system 180, the video host 110, the viewer computer system 140, and/or the network 130, among other possible system components. Thus, for the sake for brevity, the steps of process 300 shall be described as being performed by the “system.”

At step 302, the process 300 involves receiving, at a server 160, a first unique identifier associated with a video stored on a video hosting server. The first unique identifier may be, for example, a unique video identifier, such as a URL (or a portion of the URL) associated with the page of the video hosted by the video hosting service. The video itself may be accessed via an API of the video hosting server that enables it to be “embedded” (i.e., displayed for playback on a different web page) on a web page and combined with other digital content to form the digital interactive content as described herein.

At step 304, the process 300 involves creating, based at least in part on the first unique identifier associated with the video, a record in a data store. The data store may be any suitable database or the like that can store data and metadata for implementing various aspects of the present disclosure. For example, the database may store a link to the video content, the viewing status of the content (e.g., not viewed, viewed, view count, etc.), information about who has viewed the content, information about the rewards for viewing the content, information about the expiration conditions for the content (e.g., expiration date, maximum view count, etc.). The record in the data store may be assigned a second unique identifier, which can be used to retrieve data associated with the record in the data store (e.g., via an API call).

At step 306, the process 300 involves determining a uniform resource locator (URL) based in part on the second unique identifier and associated with the record in the data store. The URL may include a reference to the second unique identifier (e.g., as a part of the URL path, a URL query parameter, etc.), which facilitates database retrieval operations involved in accessing and/or generating web page content for viewing by a viewer client device.

At step 308, the process 300 involves transmitting the URL to a viewer client device. The system may transmit the URL based on an automatic workflow configured within the system (e.g., push notification, email, SMS, etc.). Alternatively, the system may enable a creator user to create one or more URLs, which can be manually sent to the intended viewer.

At step 310, the process 300 involves receiving, from the viewer client device, a request to view interactive digital content associated with the URL. The request may be, for example, an HTTP request that is created when the viewer accesses the URL in the viewer client device's web browser.

At step 312, the process 300 involves upon receiving the request, generating a web page that includes the interactive digital content. The web page may include assets such an HTML, Javascript, CSS, images, and/or other web content that is interpreted by the viewer client device's web browser to display and track interactions with the interactive digital content. In some implementations, the web page is generated by the server (e.g., server-side rendering) and served to the viewer client device as pre-rendered content. In other implementations, some of the web page content may be generated by the viewer's browser (e.g., client-side rendering), which might include various operations disclosed herein related to automatically determining where and when to display animated images overlaid onto video playback. It will be understood and appreciated by skilled persons that a combination of server-side and client-side rendering may be used to render a web page, depending on the particular implementation. Example techniques for generating the web page are described in greater detail below.

At step 314, the process 300 involves transmitting, in response to the request, the web page to the viewer client device. Transmitting the web page may involve an HTTP response that is sent responsive to an HTTP request, and may contain a combination of various web assets that instruct the viewer client device's web browser to render the interactive digital content and track the viewer's interactions therewith.

As described herein, the term “animated image” refers to a digital file format that supports both animated and static visuals, specifically designed to contain a sequence of images or frames that are displayed in succession at a certain speed to create the illusion of motion. This type of image is particularly related to the Graphics Interchange Format (GIF), which enables the encoding of short animations without the need for a separate playback program. An animated image, as defined herein, may consist of a looped or non-looped series of frames that, when played back, exhibit a moving picture. This format is commonly used for the purpose of conveying simple animations and visual effects in a compact file size, suitable for efficient transmission and display over digital platforms. File formats other than GIFs—such as the Lottie vector graphics animation file format—may also be used.

As described herein, the term “generated web page” refers to a digital content display format, dynamically created through the processing and rendering of web content assets, including but not limited to HTML (HyperText Markup Language), JavaScript, CSS (Cascading Style Sheets), and other relevant web technologies. A generated web page is characterized by its ability to be assembled or modified in real-time or near-real-time, either on the server-side, clientside, or through a hybrid approach combining both methodologies.

As described herein, “user interaction” refers to any action taken by a user to engage with content presented on a web page. This includes, but is not limited to, actions such as clicking or tapping on a specific element, hovering over content, scrolling through a page, entering data into a form, or executing a gesture that triggers a response from the web page. In the context of web analytics, user interaction is quantified and analyzed to determine user engagement, preferences, and behavior patterns.

As described herein, the term “interactive digital content” refers to multimedia elements, specifically one or more animated images, that are designed to be superimposed or overlaid onto video content during playback for brief periods. This content is not merely passive but is intended to engage the user by being responsive to user interactions, such as clicks or taps on the animated images. The interaction with these animated images is tracked, with information about the interaction (e.g., timing, frequency, nature of interaction) being captured and transmitted back to a server for analysis or further action.

Interactive digital content is characterized by its ability to enhance the viewing experience by adding a layer of engagement through interactive elements that are seamlessly integrated with the video content. These elements can serve various purposes, including but not limited to advertising, educational content, interactive storytelling, and user feedback collection. The technology underlying this interactive digital content involves sophisticated rendering and tracking mechanisms to ensure that the animated images are displayed at appropriate times during the video playback and that user interactions with these elements are accurately captured and communicated back to the server. This allows for a more immersive and interactive user experience, where the content viewed is not just consumed passively but can be interacted with, thereby providing a two-way communication channel between the content provider and the viewer.

For the purposes of the following examples, User1 is defined as the individual that triggers, invokes, or otherwise causes one or more computers (e.g., creator computer system 180, server 160, and/or other processor(s) to perform operations by executing instructions stored on a non-transitory computer-readable medium). As FIG. 1 illustrates one example system for generating interactive digital content and transmitting that interactive digital content, the following example may refer to the “system” as performing particular operations. It will be appreciated by persons having ordinary skill in the art that some operations may be performed by the server 160, the creator computer system 180, the viewer computer system 140, and/or other computing devices not explicitly shown and described with respect to FIG. 1.

In an example embodiment, User1 causes the system to create a link or uniform resource locator (URL) to interactive digital content, which can be sent to one or more recipients. In some implementations, the URL includes a unique path and/or URL query parameter(s) that refers to the interactive digital content, such that a recipient (also referred to herein as “User2”) accessing that URL in a web browser of their computing device causes that web browser to open a web page that includes the interactive digital content. Loading the web page may cause aspects of the system to carry out operations that track user behavior indicative the extent to which User2 viewed the interactive digital content and/or User2's interactions with that interactive digital content.

In an example scenario, User1 sends the URL associated with the interactive digital content to User2 via email, SMS, or other digital communication means. When User2 accesses the URL, User2's device opens a web page that loads the interactive digital content and web tracking software. The web tracking software can capture user interactions with content rendered on the web page, including but not limited to if and when User2 starts the video, pauses the video, clicks or taps on animated images superimposed or overlaid onto the video, text input by User2 in response to questions that appear on the web page, and/or other possible interactions with the videos that can be used to measure and infer the extent to which User2 paid attention to the interactive digital content. For instance, the system can measure if User2 plays back the interactive digital content in full (e.g., from start to finish without skipping), taps or clicks on every animated image that appears on screen, and/or answers question(s) correctly that appear during or after the playback of the interactive digital content.

These interactions can be stored as data and can serve as a basis for determining whether User2 viewed and adequately paid attention to the interactive digital content. In some implementations, the interaction data is transmitted from User2's device to a server, which in turn processes the interaction data (e.g., programmatically applies logic) to determine whether User2 adequately paid attention to the interactive digital content. For example, interaction data that includes a start time, a stop time, no pauses, and clicks or taps on all overlaid animated images may be deemed to be sufficient for determining that User2 adequately paid attention to the content. Whether a particular set of interactions is “sufficient, “adequate,” or “compliant” may vary among implementations, and may be defined as configurable business logic. In some cases, some degree of skipping and/or failing to tap or click on one or two animated images may be considered sufficient to deem User2 as having paid adequate attention to the content.

In some implementations, the above-described business logic processing may be performed by User2's computing device (i.e., client side) to reduce server load, reduce latency of determining the sufficiency of User2's attention to the interactive digital content, and/or for other possible reasons. Persons of ordinary skill will appreciate that web content can static, rendered on a server, rendered by a client, cached by a server and sent to a client, cached by a client, or some combination thereof. Thus, any description that refers to rendering a web page may involve operations performed on one or more computing devices of the system.

In some embodiments, the system can be configured to provide a reward to User2 upon determining that User2 adequately paid attention to the interactive digital content. In an example sequence of operations, User2's computing device may capture User2's interactions with the interactive digital content, transmit data representing those interactions to a server, process the data to determine that User2 adequately paid attention to the interactive digital content, and then responsively or automatically transmit the reward to User2. For instance, User2 may be awarded a digital gift card, with the system automatically sending a hyperlink to redeem the digital gift card to User2 via email, SMS, or other digital communication means.

In some cases, User1 might manually copy a hyperlink to a video hosted on a video hosting platform and enter it into an interactive digital content creation form of the system. Based on the hyperlink, the system can determine a unique identifier (e.g., a string of unique characters in the URL path) which can subsequently be used by the system to “embed” the video on another web page, and/or to access the video and its metadata via an API of the video hosting platform. The system can be configured to accept hyperlinks from multiple video hosting platforms, and can automatically extract the unique identifier and determine which API(s) to use based on the video hyperlink.

The system can serve as its own video hosting platform, allowing User1 to upload their own video content to form the basis of interactive digital content. In some implementations, User1 may self-host their own video content on a server, and may configure the system to access their self-hosted video content via a custom API.

The system facilitates the overlay of animated images on a video during playback. These animated images are configured to be interacted with through user input mechanisms such as mouse clicks or touchscreen taps. Specifically, as the video progresses, animated images are dynamically superimposed over the video content. Upon the appearance of an animated image, the viewer is afforded a predetermined time interval within which to interact with the image, typically by clicking or tapping on it. This time interval is determined by the system and is generally configured such that the animated image remains visible as an overlay on the video for approximately 15 seconds. Upon user interaction with the animated image, it promptly disappears from view, with the underlying video continuing its playback uninterrupted by the overlay.

The quantity and timing of the appearance of animated images overlaying a video may be determined by a combination of factors, including but not limited to the duration of the video and an underlying algorithm. This approach ensures unpredictability in the timing and sequence of animated image appearances, thereby precluding the viewer's anticipation of such events. The purpose of this methodology is to maintain viewer engagement and interaction with the content by requiring responses, such as mouse clicks or touchscreen taps, upon the sudden appearance of animated images. In some implementations, the system can dynamically calculate the frequency and intervals at which animated images are presented, based on the video's length and algorithmic parameters, to optimize viewer interaction and attention.

In some implementations, the system is optionally further configured to facilitate the presentation of questions at the conclusion of a video. This feature enables the creator of the interactive content to append multiple-choice questions to the video, thereby extending the interactive experience beyond merely viewing and interacting with animated images. Upon the successful selection of the correct answers by the viewer, a reward mechanism is activated, signifying the viewer's sufficient engagement and understanding of the video content. This aspect of the system not only augments the interactive experience but also serves as a measure of the viewer's attentiveness and retention of the presented information.

Notification mechanisms may be integrated to notify User1 upon the completion of the video viewing by User2. User1 is promptly notified when User2 has fully engaged with the video content. Additionally, the system is designed to inform User1 regarding the success or failure of User2 in interacting with the overlay elements, such as animated images, within the video. This notification process is versatile and may include various communication methods facilitated by the system, including but not limited to, electronic mail (email), Short Message Service (SMS), or push notifications, thereby ensuring timely and efficient communication between User1 and User2 regarding the interactive digital content engagement.

For example, the system may be equipped with notification framework or subsystem designed to alert User1 when User2 initiates the viewing of the interactive digital content link created and sent by User1. This framework can extend to encompass scenarios wherein User2 successfully engages with all interactive elements, such as animated images, overlayed within the video. Conversely, should User2 fail to interact with all required elements before their disappearance, the system is configured to notify User1 of this outcome as well. The notification mechanism employed by the system is adaptable and may utilize a variety of communication methods, including but not limited to, electronic mail, Short Message Service (SMS), or push notifications, thus ensuring that User1 is kept informed of User2's engagement level with the provided interactive digital content.

In some embodiments, User1 can choose to offer a reward to User2 after they have adequately viewed the interactive digital content. The provision of such a reward may be contingent upon User2 fulfilling specific engagement criteria, which may include successfully interacting with all presented animated images and watching the video content from its commencement to conclusion. In some configurations, User2 may be permitted to navigate through the video content; however, to qualify for the reward, User2 must revisit and view any portions of the video that were initially bypassed, ensuring complete engagement with all interactive elements. The nature of the reward is determined at the discretion of User1 and is communicated to User2 through the interactive content delivery system, thereby incentivizing attentive participation and interaction with the content.

The system may enable User1 to define the nature of the reward offered to User2. The parameters for defining the reward, such as its description and conditions for eligibility, can be provided by User1 into the system via designated input fields that allows User1 to articulate the specifics of the reward, thereby customizing the incentivization aligned with the desired viewer engagement outcomes. Furthermore, the system enables the setting of a deadline for the reward, such as the date and time by which User2 must complete the viewing and interaction requirements to qualify for the reward. This feature ensures clarity and motivation for User2 to engage with the video content within the stipulated timeframe.

The system can also be configured to incorporate questions for User2 to answer at the conclusion of the video. These questions are typically formatted as multiple-choice and are designed to assess User2's comprehension and attention to the video content. The successful completion of these questions, characterized by the selection of correct answers, may be deemed a requirement for User2 to “pass” and thereby become eligible for any reward specified by User1. This additional layer of interaction serves not only to enhance engagement but also to verify the viewer's understanding and retention of the video content, further enriching the interactive digital content experience.

In various embodiments of the present disclosure, the system is designed to be accessible and operational across various platforms, including web applications and mobile applications, thereby offering User1 the flexibility to generate and distribute interactive content seamlessly across different devices and mediums. The provision of a web-based interface and a mobile application ensures that User1 can engage with the system's features and functionalities in a manner that is most convenient and efficient for their specific use case, enhancing the overall usability and accessibility of the system for creating and managing interactive digital content.

In embodiments of the present invention, the software is adaptable for deployment across various industry sectors, including into devices utilized within retail environments. For instance, a tablet device pre-configured with the interactive digital content playback software described herein, and may be employed at a retail location, enabling customers to engage with video content featuring overlayed animated images and other interactive functionalities as described herein. The software can facilitate the collection of customer contact information, such as email addresses or phone numbers, as part of an interactive experience offering rewards for successful engagement with the content. This engagement includes watching the video in its entirety and interacting with all overlayed animated images within a specified timeframe. Additionally, the inclusion of questions at the end of the video, which require correct responses for successful completion, further enhances the interactive experience. This application of the software in a retail setting demonstrates its versatility and potential to enhance customer engagement and provide value through interactive digital content.

User2 may receive a reward automatically (e.g., using an automatic responder, a workflow automation, etc.), or manually from User1 after User1 determines that User2 has viewed the interactive digital content and has “passed” the interactions and/or question(s). The system may present a pop up window to User2, send an email to User2, or otherwise transmit a digital communication regarding the reward.

In accordance with certain embodiments of the disclosed system, functionality adjustments are made to accommodate the operational requirements of the interactive digital content on various devices, including but not limited to mobile devices such as Apple iPhones. These adjustments may involve modifications or limitations to certain native video player functionalities, including full-screen viewing capabilities, to ensure the seamless operation and effectiveness of the overlay interactive elements, such as animated images. The system is engineered to maintain a high level of functionality and user experience across different platforms, despite the inherent restrictions of some devices. This ensures that the interactive elements of the digital content are displayed and can be interacted with as intended, thereby preserving the integrity and intended outcome of the user engagement process.

In some implementations, the system may provide one or more inputs and/or a form before or after playback of the interactive digital content to enable User2 to enter in their contact information (e.g., phone number, email address, etc.) to which the reward is sent if User2 adequately pays attention to the content.

If User2 does not click or tap all the animated images that pop up overlayed in the video then several options are available for the software to offer. User2 would get a message either by pop up or push notification stating they failed and did not earn a reward. User2 may also get a message stating they have to try again to pass and earn the reward.

In some cases, the system offers configurable options for managing access to the interactive digital content. Upon completion of the initial viewing attempt by User2, the system can be programmed to either deactivate the unique link to the video or maintain its active status, thereby allowing for multiple attempts by User2 to engage fully with the video content. This flexibility enables the system to accommodate various engagement strategies, including limiting video access to a single view per IP address or requiring User2 to complete a registration process before viewing the content. Such configurations are designed to enhance user engagement metrics and ensure compliance with the desired interaction parameters set forth by User1, facilitating a controlled and measured distribution of interactive digital content.

In certain embodiments of the invention, the system is designed to operate independently of public video hosting platforms, such as youtube.com, providing User1 with the flexibility to host video content directly. This configuration enables the use of the software's overlay and interactive functionalities with videos that are hosted by User1, thereby offering complete control over the content and its presentation. The integration of self-hosted video content into the system allows for a seamless application of interactive elements, including animated images and end-of-video questions, without the limitations that may be imposed by third-party video hosting services. This feature ensures that all functionalities described herein, including the provision of rewards based on viewer interaction, are fully available and operational, regardless of the hosting method chosen by User1, thereby enhancing the system's versatility and applicability across a wide range of digital content distribution scenarios.

The software may be implemented using React and Laravel, among other potential web technologies, programming libraries, and/or software development kits (SDKs).

In the following section, an example interaction with a digital content creation and distribution system (shortened to “system” for the remainder of this section) between two users is described as a series of steps. It will be appreciated that variations of the below-described process are contemplated within the scope of the present disclosure. For instance, a user might generate interactive digital content and distribute it to two or more users (e.g., using an email list, database, etc.). As another example, interactive digital content may be presented to the user automatically on a web page, within a mobile application, without the viewing user necessarily having to affirmatively click on a specific link or URL. The example interaction described below is provided for explanatory purposes, and is not intended to limit the scope of any methods or systems disclosed herein.

In an embodiment of the present invention, a first step involves the input of various parameters by a user, herein referred to as User1 (e.g., the interactive digital content creator), to generate interactive digital content for a recipient or intended viewer, herein referred to as User2. The parameters may include, but are not limited to, a uniform resource locator (URL) or other identifier corresponding to a video hosted on a video hosting platform or server (e.g., YouTube or other video hosting services). Additionally, User1 may input User2's email address, details of a reward to be offered to User2 upon successful completion of the video viewing, and/or a specific due date and time for this reward to be claimed. This data may be collectively stored in a data repository (e.g., as a record in a database or other data store) along with a uniquely generated alphanumeric identifier (or other suitable identifier, such as a universal unique identifier (UUID), which may also include special characters).

Subsequent to the data entry, the system generates a unique link inclusive of the aforementioned alphanumeric identifier. This link may then be presented to User1 and simultaneously an electronic mail containing the unique link is dispatched to User1. The system further provides an option within its interface for User1 to directly copy this link.

Moreover, the system is configured to track the viewing status of the unique link, ensuring that each link is utilized for a single viewing session. However, this feature is adaptable based on the requirements of User1, allowing for multiple or unlimited views. Additionally, the system can be configured to restrict the viewing of the video to a single IP address.

The operations performed by the software during this process include the generation of the unique identifier, the creation of a corresponding unique link, transmission of all relevant information to a backend system for storage in a database, display of the link to User1, and the optional addition of the link to User1's clipboard. Furthermore, the system is responsible for the electronic transmission of the unique link to User1.

As part of the customization options available to User1, the system allows for the creation of video links through an application programming interface (API) call, thereby offering enhanced flexibility and integration capabilities.

During a second step, User 1 may disseminate the uniquely generated link for the intended recipient User2. The means of transmission for this link is not restricted and can include various forms of communication such as email, messaging platforms, and/or other forms of digital communication.

To enhance the functionality and adaptability of the system, customization options may be provided. One such option includes allowing the system to autonomously dispatch an email to User2, containing the video link. In some scenarios, such as where User1 represents an organization or entity with a sizeable audience base, an additional unique identifier, termed “user id”, can be appended to the initially generated link. This augmentation serves to facilitate precise tracking of individual video views by the audience. Additionally, it enables the limitation of video viewing to a single occurrence per user, if such a restriction is desired by User1. In instances where this customization is activated, User1 possesses the capability to configure an API callback URL, allowing the system to transmit audience viewing data back to User1.

During a third step, upon receipt of a unique link created by User1, User2 initiates access to the provided link. The system's backend component is queried to ascertain the current viewing status of the link, ensuring that each unique link is accessed for video viewing only once. This feature is configurable, allowing for modifications by User1 to permit multiple views of the same video content, as detailed in the customization options described in Step 2.

The aforesaid process is adaptable to accommodate multiple views of the same link, subject to the preference and configuration set by User1. This flexibility is integral to the system's design, providing a customizable viewing experience.

In the execution of this step, the system performs several critical functions. It verifies whether User2 has previously accessed the video linked. If the video has already been viewed, and User1 has elected to restrict the video to a single viewing, the system will prevent a subsequent viewing. Additionally, if User1 has utilized the customization option in Step 2, wherein an additional unique identifier (user ID) is incorporated, the system will check if the video has already been accessed by the specific user associated with the added user ID.

User1 may choose to implement further customization options, such as requiring User2 to undergo a registration or simplified login process before accessing the video. This could involve, for example, a security code delivered to User2's email. This additional layer of user verification serves to enhance the control and tracking capabilities of the system with respect to video viewership.

During a fourth step, upon the recipient User2 initiating the process by clicking on a uniquely generated link provided by the originator, User1, the video link is embedded and commences playback. The term “embedding” in this context does not strictly imply the incorporation of the video within a webpage surrounded by other content. Rather, it is intended to replicate the experience of a standalone video player, thereby enhancing the viewer's engagement. In scenarios where the video is directly hosted on our server, the traditional concept of embedding may not be utilized; instead, the video would be played within a video player interface.

In addition, the system may monitor the duration for which User2 views the video and execute queries to the corresponding video API (e.g., at a frequency of three times per second, among other possible frequencies). During playback, animated images may be superimposed over the video at random intervals. In some embodiments, these animated images are not embedded within the video files, but are instead overlaid during playback. However, custom file formats that package the animated images or the like with the video may be implemented, similar to known methods for optionally overlaying subtitles onto videos (e.g., where a particular animated image may be denoted to be shown for a specified period in a specified location on the video, such that a video player configured to read that custom file format would be able to orchestrate the animated image overlay sequence).

In some embodiments, the duration for which each animated image is displayed is generally set to 15 seconds, subject to certain exceptions, such as videos shorter than 15 seconds in length. In some cases, User2 is required to interact with each animated image, through clicking or tapping, before it disappears. The system may automatically determine the number of animated images to be displayed based on the length of the video, with 15 seconds being an adjustable parameter within the software. The display time of animated images may vary depending on an algorithm, parameter(s), and/or business logic.

The positioning of the overlaid or superimposed animated images may be achieved using CSS styling, where the dimensions and placement are determined as a percentage of the video's width and height, ensuring proportionality regardless of video size. Other techniques may also be used to configure the positioning, orientation, and dimensions of the animated image(s).

In a specific embodiment, the selection and positioning of animated images are randomized. The horizontal and vertical placement is determined through a random algorithm, ensuring the overlay images appear at different locations on the video screen. The software may allow for customization of these images, including shape, color, and content, based on user preferences or requests. Randomization may be desirable to reduce the amount of work involved for User1 to create interactive digital content. As described herein, the term “random” encompasses methods and algorithms that may or may not be purely random. For instance, some amount of logic may be applied to the animated image placement (e.g., a specified margin at the edges of the video), with random animated image placement being constrained by those margin constraints. As another example, the randomly-generated positions of two or more animated images may be subject to additional rules—such as requiring a minimum distance between the positions of two or more animated images—which might result in the system repeating the random generation process.

The system may be designed to detect if User2 advances the video timeline or otherwise skips to a specific point in time in the video, and in turn prompts User2 to return to the missed segment. User2 may be permitted to resume viewing post-skip, provided they revisit the unwatched portion of the video. During this catch-up phase, no new animated images are introduced; however, any animated images already displayed remain visible for their full duration. In one embodiment, this skip checking mechanism can be implemented by continuously or periodically comparing the current playback time with a reference point, ensuring that the viewer watches the video sequentially without substantial skips.

Upon the conclusion of the video, the system may verify the viewing completeness. If skipping is detected, User2 is instructed to revisit the skipped portion. Completion of the video from start to finish without skips may be a prerequisite for proceeding to Step 5.

Notably, in certain implementations, full-screen viewing on some mobile devices is restricted to ensure the visibility of the overlay animated images. Instead, the video viewport is maximized to enhance the viewing experience. On platforms where native full-screen options are available, an alternative full-screen mode is provided that encompasses the entire website, creating a full-screen effect. This approach is particularly applicable on certain devices (e.g., iPhones), where limitations exist on full-screen capabilities that could otherwise hinder the display of overlay animated images.

In this manner, the system can ensure continuous or periodic tracking of the video viewing, with the appearance of animated images being contingent on uninterrupted watching. This feature ensures that if a viewer skips forward or revisits a previously watched segment, the overlaid animated images are temporarily suspended until the viewer resumes watching the video sequentially.

During a fifth step, subsequent to the completion of the video playback, the system determines whether User2 has successfully engaged with each of the animated images. The system then categorizes the outcome as either a successful interaction or a failure. Concurrently, the software communicates with the server to update the status of the video as viewed. This functionality, however, is configurable within the software framework, thereby allowing for the possibility of repeated viewings of the video, if so desired by User1.

The system's operational logic can include an assessment of whether User2 has viewed the video without engaging in skipping behavior. If User2's viewing is deemed compliant with the prescribed criteria, this information is relayed to the server. As a result, the server updates the viewed status of the video link. This feature is subject to customization based on User1's preference. For instance, User1 can choose to limit User2's ability to view the video more than once.

During a sixth step, subsequent to the determination of User2's interaction with the video content and the interactive elements, the system may transmit a notification to User1. This notification could be in various forms, including but not limited to, an email, an SMS message, or a push notification, and is intended to confirm whether User2 successfully interacted with the video and achieved a “pass” status. Concurrently, User2 may receive a communication, utilizing similar channels, which serves as an affirmation of their successful interaction with the video content and interactive elements, and provides details regarding the earned reward, including any relevant due dates and deadlines for reward redemption. This dual-notification process may be desirable to ensure that both User1 and User2 are promptly and accurately informed about the outcome of the interaction with the video content.

In various embodiments of the present disclosure, the selection and positioning of animated images during video playback may be determined randomly but bounded within a region of the video content (e.g., a central portion of the video content surrounded by a margin). The determination of the precise location for displaying each animated image on the screen adopts a randomized algorithmic approach. To calculate the horizontal positioning, a random value may be generated within the range of 0% to 85% of the width of the video player (among other possible ranges), defining the left edge of the animated image. Similarly, for the vertical positioning, a random value may be chosen within the range of 0% to 78% of the height of the video player (among other possible ranges), defining the top edge of the animated image. This example animated image positioning method ensures that the animated image occupies a designated size relative to the video—such as 15% of the screen width and 22% of the screen height—thereby maintaining an appropriate scale for user interaction without obscuring the underlying video content.

In various embodiments, a set of ten animated images is curated, from which one or more animated images is selected (e.g., randomly, manually, based on the video content, etc.) for presentation. The system can provide for configurable design attributes of the animated images—including shape, color, and content—which can be predetermined or configurable by a creator of the interactive digital content. In some cases, the system can be adapted to allow for user-specified animated images based on individual requests or preferences, thereby enhancing and personalizing the interactive experience and engagement of the viewer with the digital content.

In various embodiments, the method employed for monitoring user interaction with embedded video content may incorporate a sophisticated mechanism for tracking the temporal progression of video playback. This can be achieved, for example, by conducting periodic queries, at a rate of three times per second, to ascertain the current playback time, herein referred to as point A. Concurrently, a reference variable, denoted as B, is initialized to the video timestamp of 00:00. The system is designed to update variable B to match point A, provided that A is within a two-second interval following B. This approach ensures that B accurately represents the continuous extent of video watched by the user, accounting for minor discrepancies not exceeding a two-second threshold. Such discrepancies may arise due to factors including but not limited to network latency, device performance limitations, or brief interruptions in connectivity, thereby distinguishing between negligible skips attributable to technical constraints and substantive navigational actions by the user, such as forwarding or rewinding beyond the two-second allowance.

In addition, the determination of the display timing for graphical interface elements, such as animated images, as well as the assessment of whether the user has viewed the video to its conclusion, may be predicated on the value of B rather than A. This ensures that engagement metrics and content interaction assessments are based on continuous viewing activity. Should the user advance the playback beyond the two-second threshold, or alternatively, navigate backward, the progression of B is halted until such time as A returns to a point within zero to two seconds (among other durations) subsequent to B, at which juncture B resumes its forward trajectory in alignment with A. This methodology enables a precise and nuanced understanding of user engagement, distinguishing between intentional user actions and minor variances due to external factors, thereby enhancing the accuracy of engagement and viewership metrics.

In an example embodiment, a tag management system, such as Google Tag Manager, may be utilized to facilitate the implementation of an interactive digital content generation and tracking system. A tag management system or the like can enable the dynamic insertion and management of code snippets, or “tags,” into a digital environment without directly modifying the source code of the digital content or application. Specifically, the system can employ tags to initiate the display of interactive digital content, including videos and animated images, and to capture user interactions with said content. By integrating tags configured to respond to specific triggers, such as the loading of a video or the appearance of an animated image, the system can dynamically generate and present interactive elements to the user, thereby enhancing user engagement and interaction with the content.

In addition, the tag management system can serve as a central repository for managing and deploying analytics and tracking tags that collect data on user behavior. For example, when a user interacts with the interactive digital content, such as by clicking or tapping on an animated image overlaid on a video, this interaction can trigger a tag that records the event and transmits the collected data back to a server for analysis. The server, in turn, can process this data to determine the level of engagement and interaction, which may include metrics such as the number of interactions, the duration of video playback, and the completion of interaction criteria such as interacting with all presented animated images. Based on this analysis, the system may further determine eligibility for rewards or further actions to be taken, enhancing the overall effectiveness of the digital content in engaging users. Thus, the integration of a tag management system such as Google Tag Manager with the present system for generating and presenting interactive digital content can enable a highly efficient, scalable, and flexible approach to deploying interactive digital content and tracking user engagement and behavior.

In the context of the present disclosure, web tracking technologies (e.g., Google Tag Manager, Meta Pixel, etc.) offer a robust mechanism for gathering detailed insights into user interactions with interactive digital content. For instance, upon the initiation of the web page containing the interactive content, web tracking software can monitor and capture a multitude of user activities, including but not limited to, starting and pausing videos, clicking or tapping on superimposed animated images, and responding to questions presented on the web page. This data, indicative of user engagement and interaction, can be analyzed to determine the depth of user involvement with the interactive content, facilitating a nuanced understanding of user attention levels and interaction patterns.

Some web tracking technologies may use URL parameters, Urchin Tracking Module (UTM) parameters, cookies, and/or other methods to track information related to the user (e.g., demographic information), previous web page(s) that the user visited before accessing the interactive digital content, and/or information to determine or estimate the user's approximate geographic location, among other user information. In various embodiments, such web tracking technology may be implemented to estimate how many users have viewed the interactive digital content, demographic information about multiple users that have viewed the interactive digital content, where in the world the interactive digital content is being viewed, and/or more detailed analyses about the users that have viewed the interactive digital content. For instance, the system may analyze IP addresses and other digital footprints left by the viewer's device, infer demographic characteristics such as age, gender, and interests, and/or pinpoint the viewer's geographic locale with a reasonable degree of accuracy. This information, in turn, can enable content creators and advertisers to measure the viewership of their digital content more effectively and determine whether it resonates with the intended audience. Additionally, the geographic data may enable the system to optimize content delivery based on regional preferences and compliance with local regulations, thereby enhancing the overall user experience and engagement with the digital content.

In an example embodiment, upon a user interacting with an animated image—such as by clicking or tapping—the system can be configured to provide immediate visual feedback by modifying properties of the animated image. For example, an interaction may trigger a change in the animated image's properties (e.g., using CSS, JavaScript, or the like) to alter aspects such as size, orientation, opacity, or color. For instance, a successful click or tap could initiate an animation that increases the image's size temporarily or changes its color, thereby visually confirming the user's interaction. In this way, the system can leverage reactive web technologies to dynamically respond to user inputs, enhancing the interactive digital content's user engagement and interactivity.

In another embodiment, the system is configured to provide visual feedback to a user's interaction with an animated image by replacing the initially interacted image with an alternative animated image. Upon the user's successful click or tap on the initial animated image, a subsequent animated image is rendered in its place (e.g., fireworks, an explosion, etc.), serving as an indication that the interaction was successfully registered. This replacement can be achieved through JavaScript and CSS manipulations, where the original animated image's HTML element is dynamically altered to display a new animated image with potentially distinct visual properties, such as differing animations, colors, or symbols. This method enriches the user experience by offering a clear and immediate visual cue of successful interaction, thereby enhancing the engagement with the interactive digital content.

In a further embodiment, the system can provide for an enhanced interactive digital content experience by displaying multiple different animated images concurrently, among which one is designated as the “correct” image to interact with, and the others as “incorrect.” Prior to playback, the user is instructed to click or tap solely on the specified animated image, effectively ignoring the others. This configuration necessitates the user's attentiveness and comprehension of the instructions, providing a robust measure of user engagement. Successfully interacting with the correct animated image amidst distractors not only confirms user interaction but also validates their attentive compliance with given directives, thereby elevating the confidence in the user's engagement level.

In another embodiment of the invention, upon successful interaction with an animated image, the system provides positive feedback through alternative mechanisms, such as displaying a notification box, playing a sound, initiating device vibration (where the user's device supports such functionality), or employing other suitable means of feedback. This feedback is designed to acknowledge the user's correct action in an engaging and instructive manner, further enhancing the interactive experience and ensuring that the user's attention and engagement are accurately measured. In embodiments that include “incorrect” animated images, a corresponding negative feedback animation, sound, vibration, or the like may be played back to indicate to the user that they made a mistake. It will be appreciated that various forms of feedback may be used to indicate to the user that a click or tap on an animated image was registered successfully.

Facial recognition technology offers an advanced level of security and verification for ensuring that specific individuals engage with interactive digital content, which may be particularly desirable when valuable rewards are involved. Various embodiments may incorporate facial recognition into the system of the present disclosure to significantly enhance the reliability of viewer engagement metrics, especially for high-value interactions such as those involving celebrities or influencers. In an example embodiment, the system would not only track clicks or taps on overlaid animated images but also verify the identity of the viewer in real time or near-real time, ensuring that the person who is supposed to watch the content is indeed the one interacting with it.

For instance, upon initiating the viewing of the interactive digital content, the viewer's device could activate its camera to periodically capture facial data (in some cases, multiple times at a predetermined interval or at random intervals while the interactive digital content is being played). This data would then be analyzed by facial recognition algorithms to confirm the viewer's identity against a pre-verified image or database of authorized viewers. This process could be designed to be minimally intrusive, with facial data captured at random intervals or at the beginning and end of the viewing session to confirm continuous presence. The system could employ sophisticated security measures to protect privacy, such as encrypting facial data and ensuring it is processed locally on the device or securely transmitted to a server for verification. In some implementations, facial recognition-based identity verification may be performed using built-in biometric authentication systems of the user's device's operating system.

Such a secure verification process may ensure that only the intended viewer can unlock the reward, making it a preferable approach for scenarios where direct engagement by a specific individual is particularly important. For instance, a brand could offer a substantial reward to a celebrity for viewing an advertisement and providing feedback, with facial recognition providing a high level of assurance that the celebrity personally engaged with the content. Such an approach not only enhances the credibility of viewer engagement metrics but also provides a secure, automated method for enforcing compliance with viewing requirements, particularly when high-value incentives are at stake.

In some implementations, an enhanced user verification process can involve facial recognition technology in conjunction with document verification to elevate the integrity and reliability of user identity authentication. Prior to accessing the interactive digital content, users may be prompted to input their full name and initiate their device's video camera to capture a photograph of themselves alongside a government-issued identification document, such as a national identity card or driver's license. This process facilitates a dual-layered verification mechanism, wherein the system employs face-detection algorithms to analyze the photograph of the user in comparison with the facial image on the provided identification document.

Then, the system may calculate a probability metric indicating the likelihood of identity misrepresentation or “cheating.” This metric may be calculated based on the degree of similarity between the user's facial features as captured in the live photograph and those on the identification document, alongside other biometric and document authenticity verification factors. Should this probability exceed a predefined threshold, indicating a high likelihood of fraudulent activity, the system may alert an administrator or creator of the system-enabling a system administrator to undertake a review of the captured images and verification data. Such a multi-step identity review process can enable a more nuanced assessment of the verification attempt, ensuring that legitimate users are not unduly penalized due to algorithmic discrepancies while maintaining a rigorous standard against unauthorized access. This approach thereby ensures a high fidelity of user identity authentication, reinforcing the security measures safeguarding the access to valuable interactive digital content and associated rewards.

In another embodiment of the invention, the system may enhance the security and verification process for interacting with digital content through the incorporation of a user authentication mechanism prior to the viewing of interactive digital content. This process involves the viewer logging in (e.g., entering in a username or email address and a password), thereby providing an initial layer of identity verification. This authentication step ensures that access to the content and subsequent rewards is restricted to authenticated users, enhancing the integrity of user engagement metrics. The login mechanism is designed to be a prerequisite for accessing the interactive digital content, thereby ensuring that only authorized viewers can initiate the content viewing process and interact with the overlaid animated images. The authentication data, securely stored and managed within the system's data store, further allows for the tracking and analysis of individual viewer interactions, enabling more precise attribution of engagement and reward eligibility.

Furthermore, facial recognition technology can be seamlessly integrated into the login process as an additional or alternative method for user authentication. In this scenario, the viewer can authenticate their identity by simply looking into the device's camera, where facial recognition software verifies the individual's identity against pre-registered facial data. This method offers a user-friendly, secure, and efficient way to access interactive digital content, eliminating the need for remembering passwords while providing a high level of security. The combination of traditional login credentials with the option for facial recognition-based authentication offers a robust framework for ensuring that the engagement with the digital content is both authenticated and accurately attributed to the correct individual, particularly important in scenarios where the content is sensitive or the rewards for engagement are significant.

In a further embodiment, the viewer may be asked to grant access to their device's webcam prior to the commencement of interactive digital content playback-enabling the Media Capture and Streams API (i.e., a standardized interface that facilitates real-time access to video and audio media streams via a device's webcam and microphone) to capture images while the interactive digital content is being displayed. Upon initiating the interactive digital content, the viewer is prompted to authorize webcam access. Failure to grant permission, or if the viewer's browser lacks support for the Media Capture and Streams API, results in the interactive content not being initiated, thereby ensuring a critical layer of verification is maintained.

At or before the start of the video playback, the webcam may activate to capture images of the viewer at one-second intervals throughout the duration of the video playback. These images are then transmitted to the server for analysis aimed at detecting anomalies such as the absence of a face in the picture, the presence of multiple individuals, or significant deviations in the viewer's presence from the initial capture. The system can define an error threshold to evaluate these anomalies. Upon surpassing this threshold, indicative of potential fraudulent viewing or noncompliance with the viewing verification process, the server communicates with the frontend to halt the video playback. An alert is subsequently displayed to the viewer, elucidating the nature of the detected anomaly and instructing them to ensure their consistent visibility on the webcam for the video to proceed. In so doing, the system can optionally enforce rigorous adherence to viewing requirements, thus safeguarding the integrity of engagement metrics and the authenticity of viewer participation.

In an exemplary embodiment of the present disclosure, the system can provide users with the capability to create personalized accounts, facilitating a more streamlined and secure method for the issuance and management of digital rewards. Each user account may be equipped with a digital “wallet” feature, which serves as a repository for accumulating points or monetary rewards earned through interaction with the interactive digital content. For example, a user account may be associated with record(s) in a database which track rewards granted to that particular user and can serve as a basis for performing accounting and distributing funds at the request of the user. This approach not only enhances user engagement by providing tangible incentives for participation, but also introduces a versatile platform for managing accrued benefits.

The digital wallet integrated into the user's account may be designed to support a variety of monetary distribution methods, thereby offering users flexibility in how they choose to utilize their rewards. For instance, upon accumulating a certain threshold of points or funds, users have the option to withdraw their earnings directly to their bank account, facilitating a seamless transition of value. Alternatively, users may opt to transfer their rewards to a money transfer service, enabling the convenient allocation of funds across different platforms. For those preferring non-monetary rewards, the system provides the option to convert accrued points into digital gift cards, applicable across a wide range of retail partners. This multifaceted approach to reward distribution underscores the system's commitment to providing a user-centric experience, catering to diverse preferences and financial needs.

In an example implementation, the system may be configured to track the distribution and status of rewards as data associated with the user's account until such time as the user decides to transfer the funds out of the interactive digital content system. Such a tracking mechanism can help maintain an accurate record of earned rewards, pending withdrawals, and completed transactions, thereby providing users with real-time insights into their account status. By leveraging advanced data analytics, the system may offer personalized recommendations and incentives, further enriching the user experience and fostering a deeper engagement with the digital content over time.

In an example embodiment, the system can distribute rewards as cryptocurrencies, in support of a growing demand for digital currency transactions. Users can link their cryptocurrency wallets to their accounts on the system by, for example, providing the public address of their wallet. This integration facilitates a direct and secure method for transferring cryptocurrency rewards from the system to the user's wallet, leveraging the inherent security and transparency features of blockchain technology. The linking process may be designed to be userfriendly, requiring minimal technical knowledge, while ensuring a high degree of security through encryption and secure communication protocols to protect sensitive information.

Once a user's cryptocurrency wallet is linked to the system, rewards earned through engagement with interactive digital content may be issued as cryptocurrency. The system converts the accrued points or monetary value of the rewards into an approximately equivalent amount in the chosen cryptocurrency (e.g., based on real-time exchange rates or using a stable token). This conversion process may be substantially automated, such that users receive a fair value for their rewards. Distribution of cryptocurrency rewards may be executed through blockchain transactions, where the system initiates a transfer from its cryptocurrency wallet to the user's wallet using the provided public address. Each transaction is recorded on the blockchain, providing an immutable and verifiable ledger of all rewards distributed to users. This method not only enhances the speed and efficiency of reward distribution but also introduces an additional layer of security and trust in the rewards mechanism.

To further streamline the rewards process and accommodate the diverse preferences of users, the system may support multiple cryptocurrencies, allowing users to select their preferred digital currency for receiving rewards. The system's backend infrastructure may be adapted to handle the complexities of interacting with various blockchain networks to achieve seamless and timely distribution of rewards. Moreover, the system can provide users with detailed transaction histories, enabling them to track their rewards from the moment they are issued to their successful receipt in the designated cryptocurrency wallet.

In an example embodiment of the present disclosure, a crowdfunded reward system may be provided to aggregate financial contributions from a multitude of participants (hereinafter referred to as “contributors”) to incentivize a specific individual, notably a celebrity or influencer, to engage with digital interactive content. This system enables a system administrator to initiate a crowdfunding campaign via a unique link, through which contributors can register and allocate funds towards the campaign. The cumulative funds can be stored and accounted for within the system and earmarked for the targeted individual after they interact with the specified digital content.

The crowdfunded reward mechanism may involve specifying a target amount and the target recipient, such as their picture and email address, with the system generating a unique, secure link associated with the campaign. This unique link, containing the specific reward offer, is disseminated at the discretion of an administrator of the system, who may extend an invitation to the target recipient through various communication channels. Upon accessing the link, the target recipient is presented with the reward proposition and is required to initiate the video playback. To ensure the authenticity of engagement, the target recipient is prompted to activate their webcam, enabling the system to employ facial recognition technology as described herein to verify the identity of the target recipient against the profile picture previously uploaded. Employing such a verification process may be desired to confirm that the actual engagement with the digital content is by the intended individual.

Upon successful verification of target recipient's engagement with the content, the system administrator may be afforded the opportunity to manually review the saved data and captured webcam images to ascertain the fulfillment of the engagement criteria. Once the target recipient's identity has been confirmed, the system releases of the crowdfunded amount to the target recipient, ensuring the contributors' intentions are honored and the rewards are disbursed appropriately. In this manner, the system can facilitate the aggregation and distribution of rewards for a target recipient attentively watching a particular piece of digital content.

In various embodiments, the system may provide for two types of user accounts: creators (sometimes referred to as “administrators”) and viewers. A user can register as a creator, manage payment sources for rewards (e.g., credit card, debit card, or other payment processing system), initiate the creation of interactive digital content, track the viewing of that interactive digital content, and disburse rewards to viewers. Likewise, a user can register as a viewer, review interactive digital content assigned to them for viewing, track their rewards earnings, and cash out payments from their digital wallet.

In some implementations, the system can implement a rating system for creators and viewers. For instance, if a viewer receives an adequate reward for viewing digital interactive content which is paid out timely by the creator, the viewer might rate the creator highly. Conversely, if the viewer doesn't receive their reward for viewing digital interactive content, or the creator took a long time to disburse the reward, the viewer might rate that creator poorly. Likewise, creators can review particular viewers based on how quickly they review the content, how well they score in terms of their attention and accuracy of following instructions and more.

Although certain example methods and apparatus have been described herein, the scope of coverage of this patent is not limited thereto. On the contrary, this patent covers all methods, apparatuses, and articles of manufacture fairly falling within the scope of the appended claims, either literally or under the doctrine of equivalents. Accordingly, this patent specification is intended to embrace all alternatives, modifications and variations of the present invention that have been discussed herein, and other embodiments that fall within the spirit and scope of the above-described invention.

The features of the present embodiments described herein may be implemented in digital electronic circuitry, and/or in computer hardware, firmware, software, and/or in combinations thereof. Features of the present embodiments may be implemented in a computer program product tangibly embodied in an information carrier, such as a machine-readable storage device, and/or in a propagated signal, for execution by a programmable processor. Embodiments of the present method steps may be performed by a programmable processor executing a program of instructions to perform functions of the described implementations by operating on input data and generating output.

The features of the present embodiments described herein may be implemented in one or more computer programs that are executable on a programmable system including at least one programmable processor coupled to receive data and/or instructions from, and to transmit data and/or instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, for example, both general and special purpose processors, and/or the sole processor or one of multiple processors of any kind of computer. Generally, a processor may receive instructions and/or data from a read only memory (ROM), or a random-access memory (RAM), or both. Such a computer may include a processor for executing instructions and one or more memories for storing instructions and/or data.

Generally, a computer may also include, or be operatively coupled to communicate with, one or more mass storage devices for storing data files. Such devices include magnetic disks, such as internal hard disks and/or removable disks, magneto-optical disks, and/or optical disks. Storage devices suitable for tangibly embodying computer program instructions and/or data may include all forms of non-volatile memory, including for example semiconductor memory devices, such as EPROM, EEPROM, and flash memory devices, magnetic disks such as internal hard disks and removable disks, magneto-optical disks, and CD-ROM and DVD-ROM disks. The processor and the memory may be supplemented by, or incorporated in, one or more ASICs (application specific integrated circuits).

To provide for interaction with a user, the features of the present embodiments may be implemented on a computer having a display device, such as an LCD (liquid crystal display) monitor, for displaying information to the user. The computer may further include a keyboard, a pointing device, such as a mouse or a trackball, and/or a touchscreen by which the user may provide input to the computer.

The features of the present embodiments may be implemented in a computer system that includes a back-end component, such as a data server, and/or that includes a middleware component, such as an application server or an Internet server, and/or that includes a front-end component, such as a client computer having a graphical user interface (GUI) and/or an Internet browser, or any combination of these. The components of the system may be connected by any form or medium of digital data communication, such as a communication network. Examples of communication networks may include, for example, a LAN (local area network), a WAN (wide area network), and/or the computers and networks forming the Internet.

The computer system may include clients and servers. A client and server may be remote from each other and interact through a network, such as those described herein. The relationship of client and server may arise by virtue of computer programs running on the respective computers and having a client-server relationship to each other.

It should be understood that arrangements described herein are for purposes of example only. As such, those skilled in the art will appreciate that other arrangements and other elements (e.g. machines, interfaces, operations, orders, and groupings of operations, etc.) can be used instead, and that some elements may be omitted altogether, according to the desired results. Further, many of the elements that are described are functional entities that may be implemented as discrete or distributed components or in conjunction with other components, in any suitable combination and location, or as other structural elements described as independent structures may be combined.

As used herein, the phrases “at least one of A, B and C,” “at least one of A, B, or C,” and “A, B, and/or C” are synonymous and mean logical “OR” in the computer science sense. Thus, each of the foregoing phrases should be understood to read on (A), (B), (C), (A and B), (A and C), (B and C), and (A and B and C), where A, B, and C are variables representing elements or features of the claim. Also, while these examples are described with three variables (A, B, C) for ease of understanding, the same interpretation applies to similar phrases in these formats with any number of two or more variables.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A computer-implemented method for generating interactive digital content, the method comprising:
receiving, at a server, a first unique identifier associated with a video stored on a video hosting server, wherein the video is accessible via an application programming interface (API) of the video hosting server over a network;
creating, based at least in part on the first unique identifier associated with the video, a record in a data store, wherein the record stores at least the first unique identifier in association with a second unique identifier;
determining a uniform resource locator (URL) based in part on the second unique identifier and associated with the record in the data store;
transmitting the URL to a viewer client device;
receiving, from the viewer client device, a request to view interactive digital content associated with the URL;
upon receiving the request, generating a web page that includes the interactive digital content, wherein the interactive digital content includes at least (i) the video associated with the first unique identifier and (ii) one or more animated images,
wherein the video has a duration, and wherein generating the web page comprises:
determining, for each of the one or more animated images, a start time and an end time that occur within the duration of the video to display the respective animated image;
determining, for each of the one or more animated images, a location to display the respective animated image relative to the video; and
generating a web page that (a) displays each of the one or more animated images at their respective locations between their respective start and end times superimposed onto the video and (b) captures and transmits user interactions with content on the web page to the server; and
transmitting, in response to the request, the web page to the viewer client device.

2. The computer-implemented method of claim Error! Reference source not found., further comprising:
receiving, at the server, data indicative of user activity captured by the viewer client device while rendering the web page;
determining that the received data indicative of the user activity satisfies one or more criteria; and
based on the determination that the received data indicative of the user activity satisfies the one or more criteria, transmitting a message to a user of the viewer client device that includes information about a reward for viewing and interacting with the interactive digital content.

3. The computer-implemented method of claim Error! Reference source not found., wherein the one or more criteria includes whether the user interacted with all of the one or more animated images of the interactive digital content, and wherein determining that the received data indicative of the user activity satisfies the one or more criteria comprises:
determining, for each of the one or more animated images, that the user clicked or tapped on the respective animated image while it was shown overlaid onto the video.

4. The computer-implemented method of claim Error! Reference source not found., wherein determining that the received data indicative of the user activity satisfies the one or more criteria comprises:
determining that the user interacted with all of the one or more animated images of the interactive digital content.

5. The computer-implemented method of claim Error! Reference source not found., wherein determining that the received data indicative of the user activity satisfies the one or more criteria comprises:
determining that the user interacted with a threshold amount of the one or more animated images of the interactive digital content.

6. The computer-implemented method of claim Error! Reference source not found., wherein the generated web page further (c) displays at least one question and one or more input elements corresponding to the at least one question, and wherein the one or more criteria includes whether the at least one question was answered correctly by the user based on the state of the one or more input elements.

7. The computer-implemented method of claim Error! Reference source not found., further comprising:
receiving, at the server, data indicative of user activity captured by the viewer client device while rendering the web page;
upon receiving the data indicative of the user activity, determining that a current date and time is after an expiration date and time associated with the record in the data store; and
based on the determination that the current date and time is after the expiration date and time, notifying a user of the viewer client device that they are ineligible to receive a reward for viewing and interacting with the interactive digital content.

8. The computer-implemented method of claim Error! Reference source not found., further comprising:
receiving, at the server, data representative of user activity captured by the viewer client device while rendering the web page;
determining that the received data representative of the user activity indicates that a user of the viewer client device at least viewed the interactive digital content; and
updating the record in the data store to indicate that the interactive digital content has been viewed.

9. The computer-implemented method of claim Error! Reference source not found., wherein the request to view the interactive digital content is a first request, wherein the web page is a first web page, and wherein the method further comprises:
receiving, from the viewer client device, a second request to view interactive digital content associated with the URL, wherein the second request occurs after updating the record in the data store to indicate that the interactive digital content has been viewed;
in response to receiving the second request, determining that the interactive digital content has already been viewed based on the record in the data store; and
upon determining that the interactive digital content has already been viewed, transmitting a second web page to the viewer client device, wherein the second web page does not include the interactive digital content.

10. The computer-implemented method of claim Error! Reference source not found., wherein the data representative of user activity includes an IP address of the viewer client device, wherein updating the record in the data store to indicate that the interactive digital content has been viewed further includes storing the first IP address in the record of the data store, wherein the request to view the interactive digital content is a first request, wherein the web page is a first web page, and wherein the method further comprises:
receiving, from the viewer client device, a second request to view interactive digital content associated with the URL, wherein the second request includes the IP address of the viewer client device;
in response to receiving the second request, determining that the interactive digital content has already been viewed from the IP address based on the record in the data store; and upon determining that the interactive digital content has already been viewed from the IP address, transmitting a second web page to the viewer client device, wherein the second web page does not include the interactive digital content.

11. The computer-implemented method of claim Error! Reference source not found., further comprising:
receiving, at the server, data representative of skip events captured by the viewer client device while rendering the web page;
determining that a skip interval of at least one of the skip events exceeds a threshold interval; and
based on the determination that the interval of the at least one of the skip events exceeds the threshold interval, updating the record in the data store to indicate that the user skipped a portion of the interactive digital content.

12. The computer-implemented method of claim Error! Reference source not found., wherein determining, for each of the one or more animated images, the location to display the respective animated image relative to the video comprises:
determining a random width position from a range of width positions extending between a left margin and a right margin of the video, wherein the left margin is different from the left edge of the video, and wherein the right margin is different from the right edge of the video;
determining a random height position from a range of height positions extending between a top margin and a bottom margin of the video, wherein the top margin is different from the top edge of the video, and wherein the bottom margin is different from the bottom edge of the video; and
determining the location to display the respective animated image relative to the video as based on the random width position and the random height position.

13. The computer-implemented method of claim Error! Reference source not found., further comprising:
determining the one or more animated images as a random selection from a predetermined set of animated images.

14. The computer-implemented method of claim Error! Reference source not found., wherein transmitting the URL to the viewer client device comprises transmitting an email message to an email address associated with a user of the viewer client device, and wherein the method further comprises:
receiving, at a server, the email address associated with the user of the viewer client device, wherein the record further stores the email address associated with the viewer client device in association with the second unique identifier.

15. The computer-implemented method of claim Error! Reference source not found., wherein transmitting the URL to the viewer client device comprises transmitting a short messaging service (SMS) message to a phone number associated with a user of the viewer client device, and wherein the method further comprises:
receiving, at a server, the phone number associated with the user of the viewer client device, wherein the record further stores the phone number associated with the viewer client device in association with the second unique identifier.

16. The computer-implemented method of claim Error! Reference source not found., further comprising:
receiving, at the server, data indicative of user activity captured by the viewer client device while rendering the web page;
determining that the received data indicates that a viewer user of the viewer client device viewed the interactive digital content; and
notifying a creator user that the viewer user viewed the interactive digital content.

17. A non-transitory computer readable medium having instructions stored thereon that, upon execution by at least one processor, causes a viewer client device to perform operations comprising:
receiving, from a server, a web page that includes interactive digital content, wherein the interactive digital content includes at least (i) a video and (ii) one or more animated images, wherein each of the one or more animated images is configured to be displayed at a respective location relative to the video between a respective start time and a respective end time;
retrieving, from a video hosting platform, the video for playback; beginning playback of the interactive digital content;
receiving one or more input events representative of user activity related to the interactive digital content, wherein the one or more input events include clicks or taps on the one or more animated images while they are shown superimposed onto the video; transmitting data representative of the one or more input events to the server; and receiving, from the server, a message directed to a user of the viewer client device that includes information about a reward for viewing and interacting with the interactive digital content.

18. The non-transitory computer readable medium of claim Error! Reference source not found., wherein the operations further comprise:
obtaining video playback data that includes a playback duration of the video of the interactive digital content; and
transmitting at least the playback duration as data to the server to determine whether the viewer client device played the entire video.

19. The non-transitory computer readable medium of claim Error! Reference source not found., wherein the operations further comprise:
obtaining video playback data that includes skip events on the video of the interactive digital, wherein a skip event includes a start time and an end time; and
transmitting at least the skip events as data to the server to determine whether the viewer client device played the entire video.

20. A computer-implemented method for generating interactive digital content, the method comprising:
receiving, at a server, a first unique identifier associated with a video stored on a video hosting server, wherein the video is accessible via an application programming interface (API) of the video hosting server over a network;
creating, based at least in part on the first unique identifier associated with the video, a record in a data store, wherein the record stores at least the first unique identifier in association with a second unique identifier;
determining a uniform resource locator (URL) based in part on the second unique identifier and associated with the record in the data store;
transmitting the URL to a viewer client device;
receiving, from the viewer client device, a request to view interactive digital content associated with the URL;
upon receiving the request, generating a web page that includes the interactive digital content, wherein the interactive digital content includes at least (i) the video associated with the first unique identifier and (ii) one or more animated images, wherein the video has a duration, and wherein generating the web page comprises:
determining, for each of the one or more animated images, a start time and an end time that occur within the duration of the video to display the respective animated image;
determining, for each of the one or more animated images, a location to display the respective animated image relative to the video; and
generating a web page that (a) displays each of the one or more animated images at their respective locations between their respective start and end times superimposed onto the video and (b) captures and transmits user interactions with content on the web page to the server;
transmitting, in response to the request, the web page to the viewer client device; receiving, at the server, data indicative of user activity captured by the viewer client device while rendering the web page;
determining that the received data indicative of the user activity satisfies one or more criteria, wherein the one or more criteria includes whether the user interacted with all of the one or more animated images of the interactive digital content; and
based on the determination that the received data indicative of the user activity satisfies the one or more criteria, transmitting a message to a user of the viewer client device that includes information about a reward for viewing and interacting with the interactive digital content.
